(19) United States
(12) Patent Application Publication
(10) Pub. No.: US 2025/0314823 A1
(43) Pub. Date: Oct. 9, 2025

(54) DOUBLE CHIRP INTEGRATED WAVEGUIDE BRAGG GRATINGS

(71) Applicant: Lumentum Operations LLC, San Jose, CA (US)

(72) Inventors: Leandro Andrade Couto FONSECA, Campinas (BR); Alexandre Passos FREITAS, Campinas (BR); Fellipe Grillo PETERNELLA, Campinas (BR)

(21) Appl. No.: 18/751,634

(22) Filed: Jun. 24, 2024

Related U.S. Application Data
(60) Provisional application No. 63/575,965, filed on Apr. 8, 2024.

(51) Int. Cl. G02B 6/124; G02B 6/12

(52) U.S. Cl. CPC G02B 6/124; G02B 2006/12107

(57) ABSTRACT

A photonic integrated circuit includes a waveguide comprising a first end, a second end, and a waveguide Bragg grating (WBG) arranged between the first end and the second end. The WBG has a third end, a fourth end, and a double chirp profile that extends lengthwise, from the third end to the fourth end, along a propagation length of the WBG. The WBG includes a periodic pattern having a Bragg period that decreases, from the third end to the fourth end, along the propagation length of the WBG to form a first chirp profile of the double chirp profile. Additionally, the WBG has a waveguide effective index that increases, from the third end to the fourth end, along the propagation length of the WBG to form a second chirp profile of the double chirp profile.

### CROSS-REFERENCE TO RELATED APPLICATION

This patent application claims priority to U.S. Provisional Patent Application No. 63/575,965, filed on Apr. 8, 2024, and entitled “DOUBLE CHIRP INTEGRATED WAVEGUIDE BRAGG GRATINGS.” The disclosure of the prior application is considered part of and is incorporated by reference into this patent application.

### TECHNICAL FIELD

The present disclosure relates generally to photonic integrated circuits and to waveguide Bragg gratings.

### BACKGROUND

A photonic integrated circuit (PIC) is a compact and integrated device that incorporates multiple photonic components and functions on a single chip, similar to the way electronic integrated circuits (ICs) integrate various electronic components. The goal of a photonic integrated circuit is to manipulate and control light signals for applications in optical communication, sensing, signal processing, and other photonic technologies. Thus, the PIC is a microchip that includes an integrated optical circuit containing two or more photonic components that form a functioning circuit. Photonic integrated circuits utilize photons (or particles of light). The PIC may provide functions for information signals imposed on optical wavelengths. A waveguide Bragg grating is one type of component that may be integrated into a PIC (e.g., into an optical waveguide of the PIC).

### SUMMARY

In some implementations, an optical system includes a photonic integrated circuit comprising: a first waveguide comprising a first end, a second end, and a first waveguide Bragg grating (WBG) arranged between the first end and the second end, wherein the first WBG has a third end, a fourth end, and a first double chirp profile that extends lengthwise, from the third end to the fourth end, along a propagation length of the first WBG, wherein the first WBG includes a first periodic pattern having a first Bragg period that decreases, from the third end to the fourth end, along the propagation length of the first WBG to form a first chirp profile of the first double chirp profile, and wherein the first WBG has a first waveguide effective index that increases, from the third end to the fourth end, along the propagation length of the first WBG to form a second chirp profile of the first double chirp profile.

### BRIEF DESCRIPTION OF THE DRAWINGS

FIG. 1A shows a photonic integrated circuit according to one or more implementations.

FIG. 1B shows a first segment and a second segment of the WBG arranged at different areas of the WBG along the propagation length.

FIG. 2 shows a diagram of two chirp profiles along a WBG propagation length according to one or more implementations.

FIG. 3 shows an optical system according to one or more implementations.

FIG. 4 shows an optical system according to one or more implementations.

### DETAILED DESCRIPTION

The following detailed description of example implementations refers to the accompanying drawings. The same reference numbers in different drawings may identify the same or similar elements.

A major drawback in a performance of an optical communication systems arises from the chromatic dispersion (CD) in standard single mode fibers (s-SMFs). Modulated light signals experience phase degradation due to dispersion. For example, a typical value for CD in an s-SMF at 1550 nm is 17 ps/(nm*km). Chromatic dispersion may be related to group velocity dispersion (GVD) and may result in an impairment in optical telecommunications. After light propagation in the s-SMF, the inherent chromatic dispersion hinders a bit detection at a receiver (Rx) side. Generally, adjacent bits are overlapped at the receiver due to pulse broadening caused by a GVD of the s-SMF. A signal detection penalty caused by chromatic dispersion is widely known and can be solved in several manners, including digital signal processing (DSP) techniques, dispersion compensating fibers (DCF), optical signal bandwidth reduction, electronic bandwidth reduction, etc. Compensating for the chromatic dispersion of an optical fiber requires specific equipment to be implemented in the optical communication system, which adds system cost and complexity to a given product used for these applications. For instance, dispersion starts to be a dominant bottleneck factor in optical systems with bitrate above 40 gigabits per second (Gbps) that operate over distances higher than 5 km when using simple intensity modulation schemes, such as non-return-to-zero (NRZ) or 4-level pulse amplitude modulation (PAM4).

Some implementations described herein provide a waveguide Bragg grating (WBG) that comprises two chirp profiles (e.g., double chirp integrated waveguide Bragg grating) along a propagation length of the WBG. The two chirp profiles (e.g., a double chirp) function simultaneously to provide a phase distortion in a reflected signal that is received by the WBG. The two chirp profiles (e.g., the two chirps) in the WBG are in opposite directions, so that while one chirp is increasing along the WBG, the other chirp is decreasing, or vice versa. The two chirp profiles allow for a GVD that counteracts a chromatic dispersion accumulated in an optical signal that propagates in an optical fiber over a distance. The two chirp profiles may follow a non-linear mathematical function to attain a variable dispersion value within a Bragg reflection wavelength bandwidth. The Bragg reflection wavelength bandwidth may be much larger than an optical signal bandwidth that has a chromatic dispersion compensation. Therefore, inside a limited range of chromatic dispersion to be compensated, the Bragg reflection wavelength bandwidth may be tuned to a desired level of GVD that will counteract a given level chromatic dispersion to be compensated (e.g., within a range of chromatic dispersion compensation capability). The chromatic dispersion compensation is feasible since a WBG group delay profile may be designed to be an inverse of a group delay accumulated after a given fiber propagation distance. Moreover, due to a designed non-linear group-delay profile in a WBG reflection spectrum, a certain range of chromatic dispersion can be compensated for.

Thus, the WBG may compensate the chromatic dispersion after optical propagation in optical fibers within a given range of GVD values. The chromatic dispersion compensation may be performed with a PIC that is integrated with an optical system. While chromatic dispersion compensation may be described for operation at the C-band, around 1550 nm wavelength, with a SMF, the chromatic dispersion compensation may be applied to other chromatic dispersion penalty scenarios.

In addition, the chromatic dispersion compensation is not limited to a specific distance. Instead, the WBG may be designed to enable chromatic dispersion compensation for a range of distances. In other words, the chromatic dispersion compensation may be tunable and may support a given distance range. The specific distance range may be limited by how precise the PIC can be fabricated.

Moreover, the WBG may have two ends located at opposite ends of a propagation length of the WBG. Light may be received at either of the two ends to provide two different optical functions. For example, when light is received at a first end of the two ends, the optical function may be chromatic dispersion compensation such that a reflected optical signal output from the first end has a desired dispersion. Alternatively, when light is received at a second end of the two ends, the optical function may be to add a different dispersion, with an inverse slope over wavelength in comparison to a use as a s-SMF dispersion compensation such that a reflected optical signal output from the second end has a dispersion with the inverse slope over wavelength in comparison to the use as a s-SMF dispersion compensation. For example, when light is received at a second end of the two ends, the optical function may be compression such that a reflected optical signal output from the second end is provided as a compressed optical signal with a desired compression.

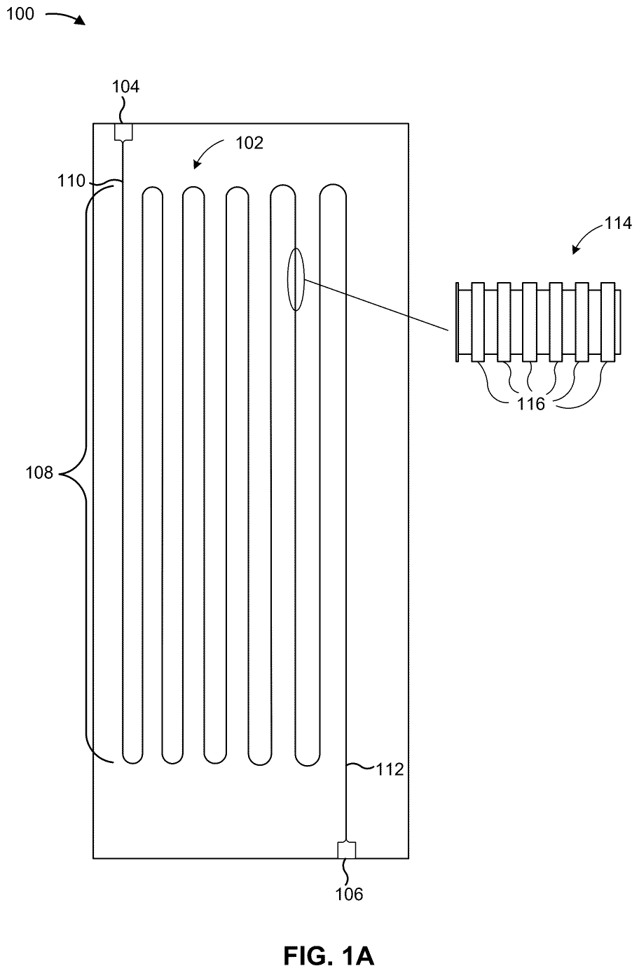

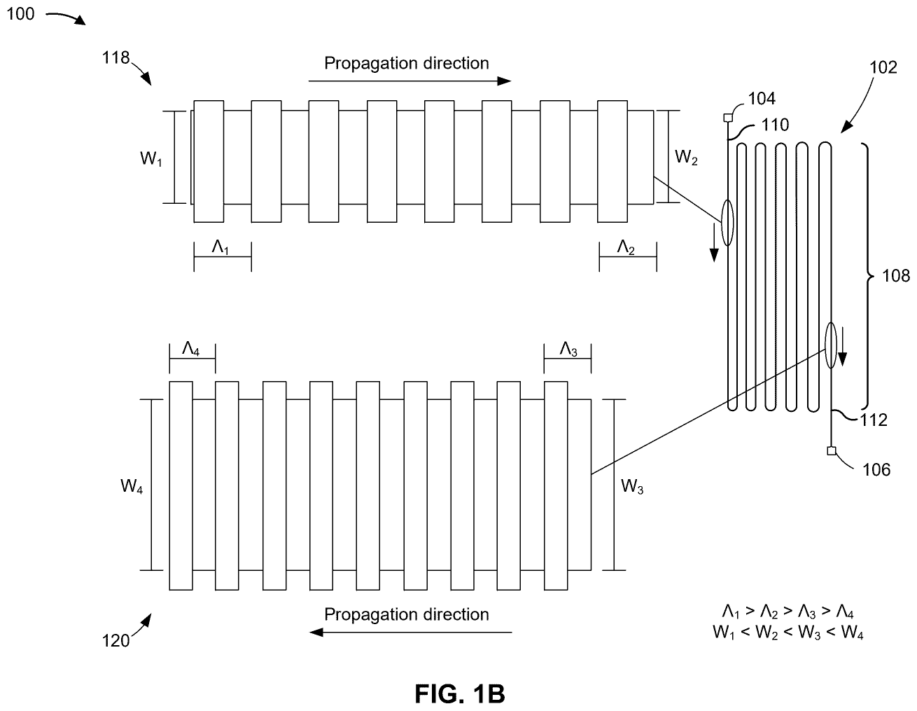

FIG. 1A shows a photonic integrated circuit 100 according to one or more implementations. The photonic integrated circuit 100 may include a waveguide 102 that includes a first end 104, a second end 106, and a WBG 108 arranged between the first end 104 and the second end 106. In some implementations, the first end 104 may be an input end for receiving an optical signal (e.g., a light signal). In some implementations, the second end 106 may be the input end for receiving the optical signal. The photonic integrated circuit 100 may provide two different optical functions. For example, when the optical signal is received at a first end 104, the optical function may be chromatic dispersion compensation such that a reflected optical signal output from the first end 104 has a desired dispersion. Alternatively, when the optical signal is received at a second end 106, the optical function may be dispersion such that a dispersion of a reflected optical signal output from the second end 106 has a slope over wavelength that is an inverse of a dispersion when using the first end 104. For example, when the optical signal is received at a second end 106, the optical function may be compression such that a reflected optical signal output from the second end 106 is provided as a compressed optical signal with a desired compression. Thus, the waveguide 102 may have a receiving end and a non-receiving end. The WBG 108 may be configured to receive the optical signal from the receiving end and reflect the optical signal back to the receiving end as a reflected optical signal for output. The receiving end of the waveguide 102 (e.g., the first end 104 or the second end 106) may be coupled to a waveguide, an optical fiber, a grating, a coupler, and/or another optical device.

The WBG 108 may have a third end 110 and a fourth end 112 that are located on opposite ends of a probation length of the WBG 108. The third end 110 may be coupled to the first end 104 of the waveguide 102 and the fourth end 112 may be coupled to the second end 106 of the waveguide 102. The third end 110 may be located at the first end 104 or may be offset from the first end 104. The fourth end 112 may be located at the second end 106 or may be offset from the second end 106.

In addition, the WBG 108 may have double chirp profile that extends lengthwise, between the third end 110 and the fourth end 112, along the propagation length of the WBG 108. The WBG 108 may have a first periodic pattern having a first Bragg period (e.g., A Bragg) that decreases, from the third end 110 to the fourth end 112, along the propagation length of the WBG 108 to form a first chirp profile of the double chirp profile. Additionally, the WBG 108 may have first waveguide effective index (e.g., n_{eff}) that increases, from the third end 110 to the fourth end 112, along the propagation length of the WBG 108 to form a second chirp profile of the double chirp profile. Thus, the two chirp profiles (e.g., two chirps) in the WBG 108 are in opposite directions, so that while one chirp is increasing along the WBG 108, the other chirp is decreasing.

A segment 114 of the WBG 108 is shown. The first periodic pattern is a perturbation pattern having a plurality of perturbation segments 116 arranged in series along the propagation length of the WBG 108. The perturbation pattern, used to obtain a Bragg reflection effect, may be achieved with a square-shaped profile. For example, the perturbation pattern may be a periodic corrugation that has a square-shaped profile (e.g., square-shaped corrugations). Other corrugation shapes to achieve the Bragg reflection effect are also applicable. In some implementations, the perturbation pattern may be shaped along the propagation length of the WBG 108 according to an apodization function.

In some implementations, the first Bragg period may be chirped along the propagation length of the WBG 108 according to a first non-linear profile, and the first waveguide effective index may be chirped along the propagation length of the WBG 108 according to a second non-linear profile. For example, the first non-linear profile may be a first square-root profile, and the second non-linear profile may be a second square-root profile. The first non-linear profile and the second non-linear profile may change in magnitude in opposite directions along the propagation length of the WBG 108.

Bragg reflection wavelength bandwidth (λ_{Bragg}) is a design parameter that is determined by a Bragg period (Λ_{Bragg}) (e.g., Bragg pitch) and a waveguide effective index (n_{eff}). Through a perturbation in the waveguide 102, over a defined length, the Bragg period is defined, which is typically repeated over several periods such that a desired Bragg reflection bandwidth λ_{Bragg} is obtained. If the Bragg period increases or decreases over the propagation length, the resulting WBG is said to be chirped over the Bragg period. If the waveguide effective index increases or decreases over the propagation length, the resulting WBG is said to be chirped over the waveguide effective index. Thus, the WBG 108 has two chirps in opposite directions. In implementations described herein, both the waveguide effective index and the Bragg pitch are chirped with specific mathematical functions.

Here, a dispersion phase profile in a WBG reflection spectrum from the WBG 108 is tailored to counteract a dispersion (e.g., chromatic dispersion) from an optical fiber (e.g., a SMF). Moreover, the WBG 108 may be designed to have a variable group-delay over its Bragg reflection wavelength bandwidth, which may enable chromatic dispersion compensation tuning. Specifically, a group-delay slope of the variable group-delay gradually may change over the Bragg reflection wavelength bandwidth and may allow for dispersion tuning through temperature tuning (e.g., the Bragg reflection wavelength bandwidth may be shifted).

The WBG 108 includes two chirps (e.g., the double chirp) such that a strong GVD is generated in the Bragg reflection wavelength bandwidth. Due to the double chirping in the WBG 108, the Bragg reflection bandwidth is characterized by a non-linear group-delay profile, such that over the Bragg reflection wavelength bandwidth different levels of dispersion may exist.

The two chirps in the WBG 108 may include (1) a chirp in a mode effective index (n_{eff}) through a waveguide geometry variation along the propagation length, and (2) a chirp in the Bragg period (Λ_{Bragg}) through a pitch variation along the propagation length. Both chirps can be created in a PIC waveguide (e.g., the waveguide 102). With the double chirp, it is possible to obtain a range of dispersion levels of interest by configuring a geometry of the WBG 108.

For example, the double chirp in the WBG 108 may be designed such that along the WBG 108, both the waveguide effective index n_{eff} and the Bragg period Λ_{Bragg} are changed with a square-root dependency along the propagation length. Moreover, the two chirps are opposite in sign. For example, the waveguide effective index n_{eff} may be increased along the propagation length, and the Bragg period Λ_{Bragg} may be decreased along the propagation length. The waveguide effective index n_{eff} of the WBG 108 may change due to variations in waveguide thickness (t), width (w), sidewall angle (α), and/or slab layer thickness. For example, the waveguide effective index n_{eff} may be proportional to a WBG waveguide width. Thus, the waveguide effective index n_{eff} may be increased along the propagation length by increasing the WBG waveguide width along the propagation length. The WBG waveguide width may be increased along the propagation length with a square-root profile.

A resulting joint effect of the double chirp is an increment on an overall WBG reflected light dispersion, since the waveguide effective index n_{eff} and the Bragg period Λ_{Bragg} are dependent on each other and follow a Bragg equation for Bragg mirrors, provided by Equation 1.

$${λ}_{Bragg} = 2 {n}_{eff} \cdot {Λ}_{Bragg} , \qquad Eq . 1$$

where λ_{Bragg} is the Bragg reflection wavelength, Λ_{Bragg} is the Bragg period, and n_{eff} is the waveguide effective index. In particular, the two chirps act to change the Bragg reflection wavelength λ_{Bragg} such that each grating segment of the WBG 108 contributes a local Bragg reflection to an overall Bragg reflection of the WBG 108. A derivative over a WBG position (variable z, from zero to L_{WBG}—a total WBG length) is provided by Equation 2:

$$\frac{\partial {λ}_{Bragg}}{\partial z} = 2 \frac{\partial {n}_{eff}}{\partial z} \cdot Λ + 2 {n}_{eff} \cdot \frac{\partial Λ}{\partial z} . \qquad Eq . 2$$

According to Equation 2, strong variations in the Bragg reflection wavelength λ_{Bragg} are obtained by having strong waveguide effective index n_{eff} and Bragg period Λ_{Bragg} derivatives. However, in a photonic integrated circuit, such a geometry is limited by foundry capabilities. In this sense, on one hand, a sharp chirp results in a desired stronger dispersion in the WBG reflection wavelength. On the other hand, fabrication a structure with subtle variations in the waveguide effective index n_{eff} and Bragg period Λ_{Bragg} is much more challenging. Moreover, since the dispersion is compensated for through light propagation along the propagation length, the waveguide 102 should be made with low-loss materials (core and cladding) and should be made with smooth sidewall surfaces.

By tailoring a chirp with a non-linear function (e.g., a square-root profile), a non-linear group delay can be generated with the WBG 108. Moreover, when a second chirp is added to the WBG 108, resulting in the double chirp structure, the effect of providing a non-linear group delay is enhanced. The WBG 108 featuring two chirps in one device enables the dispersion to be increased. Furthermore, the two chirps in a single waveguide may alleviate manufacturing issues, since the double chirp design allows extra flexibility on the design of challenging WBG conditions by splitting intricacies related to fabrication within the features of each chirp. As an example, given a WBG with a fixed length, more dispersion can be achieved by using the double chirp approach as described herein (two chirps with opposite signs) than compared to a single chirp approach.

To avoid group-delay ripples, an apodization function may be applied to both perturbations (both chirps) over the propagation length (e.g., chirp apodization). Thus, chirp apodization may be applied to both chirps in the double chirp design of the WBG 108.

In some implementations, the photonic integrated circuit 100 may include two or more waveguides, with each waveguide having a respective WBG. Each respective WBG may have a different double chirp profile. The photonic integrated circuit 100 may be coupled to an optical selector which may select which waveguide will receive an optical signal.

As indicated above, FIG. 1A is provided as an example. Other examples may differ from what is described with regard to FIG. 1A.

FIG. 1B shows a first segment 118 and a second segment 120 of the WBG 108 arranged at different areas of the WBG 108 along the propagation length. For example, the first segment 118 may be arranged proximate to the third end 110, and the second segment 120 may be arranged proximate to the fourth end 112.

The Bragg period Λ_{Bragg} of the WBG 108 may decreases incrementally along the propagation length of the WBG 108 according to a first plurality of increments, and the waveguide effective index n_{eff} of the WBG 108 may increase incrementally along the propagation length of the WBG 108 according to a second plurality of increments. The first plurality of increments and the second plurality of increments may be non-linear increments such that each subsequent variation is slightly different from a previous variation. For example, the first plurality of increments and the second plurality of increments may change based on a non-linear mathematical function, such as a square-root function. As a result, the first segment 118 has a first Bragg period Λ1 and second Bragg period Λ2 that is smaller than the first Bragg period Λ1 (e.g., the Bragg period Λ_{Bragg} decreases incrementally along the propagation length of the first segment 118 along the propagation direction). Additionally, the second segment 120 has a third Bragg period Λ3 and fourth Bragg period Λ4 that is smaller than the third Bragg period Λ3 (e.g., the Bragg period Λ_{Bragg} decreases incrementally along the propagation length of the second segment 120 along the propagation direction). In addition, the first segment 118 has a first width W1 and second width W2 that is greater than the first width W1 (e.g., the width W increases incrementally along the propagation length of the first segment 118 along the propagation direction). Additionally, the second segment 120 has a third width W3 and fourth width W4 that is greater than the third width W3 (e.g., the width W increases incrementally along the propagation length of the second segment 120 along the propagation direction). Since the waveguide effective index n_{eff} is related to the width W of the WBG 108, the waveguide effective index n_{eff} increases as the width W increases. In other words, the WBG may have a variable dimension that increases along the propagation length of the WBG 108 such that the waveguide effective index n_{eff} increases along the propagation length of the WBG 108. The variable dimension is a variable width or a variable height.

The periodic pattern of the WBG 108 may be a corrugated pattern having a plurality of corrugation segments, and a pitch between consecutive pairs of corrugation segments may decrease along the propagation length of the WBG 108 (e.g., in the propagation direction). As a result, the Bragg period Λ_{Bragg} may decrease incrementally along the propagation length of the first segment 118 along the propagation direction.

Thus, the first chirp profile may be a WBG perturbation profile, the second chirp profile may be a waveguide effective index profile, and the WBG 108 may have a Bragg reflection wavelength bandwidth that depends on the first chirp profile along the propagation length of the WBG 108 and the second chirp profile along the propagation length of the WBG 108. As a result, the Bragg reflection wavelength bandwidth changes along the propagation length of the WBG 108. Based on the double chirp profile, the WBG 108 has a Bragg reflection bandwidth that is characterized by a non-linear wavelength-dependent group-delay profile such that different levels of chromatic dispersion are provided over the Bragg reflection wavelength bandwidth.

The waveguide 102 may receive an optical signal at the first end 104 such that the WBG 108 receives the optical signal at the third end 110. The WBG 108 may reflect the optical signal by a plurality of local reflections as the optical signal propagates from the third end 110 toward the fourth end 112 resulting in a reflected optical signal that is output from the first end 104. The WBG 108 may provide a phase delay response to the optical signal, for generating the reflected optical signal, based on the Bragg reflection wavelength bandwidth of the WBG 108. In other words, the WBG 108 may be configured to reflect the optical signal to introduce a phase distortion in the reflected optical signal with a phase delay response from the WBG 108. The phase delay response is a non-linear phase delay response that depends on the Bragg reflection wavelength bandwidth of the WBG 108 (e.g., based on the non-linear chirp profiles). The phase distortion may be an inverse to a transmission phase distortion introduced by a transmission of light through an optical fiber that is coupled to the first end 104. Thus, the WBG 108 may compensate for a range of chromatic dispersion values from the optical fiber. The range of chromatic dispersion values may correspond to a given distance range of propagation through the optical fiber. The transmission phase distortion introduced by a transmission of light through an optical fiber may correspond to the given distance range of propagation through the optical fiber. For example, the longer the distance, the greater an amount of transmission phase distortion may be introduced by the optical fiber. Thus, the double chirp profile of the WBG 108 may provide a phase distortion in the reflected optical signal that is configured to counteract a chromatic dispersion that accumulates in the reflected optical signal as the reflected optical signal propagates in the optical fiber over a predefined distance.

In some implementations, the waveguide 102 may receive an optical signal at the second end 106 such that the WBG 108 receives the optical signal at the fourth end 112. The WBG 108 may reflect the optical signal by a plurality of local reflections as the optical signal propagates toward the third end 110 resulting in a reflected optical signal that is output from the second end 106. Thus, the Bragg period Λ_{Bragg} may be increasing and the waveguide effective index n_{eff} may be decreasing along the propagation direction of the optical signal. As a result, the WBG 108 may compress the optical signal to generate the reflected optical signal as a compressed optical signal.

As indicated above, FIG. 1B is provided as an example. Other examples may differ from what is described with regard to FIG. 1B.

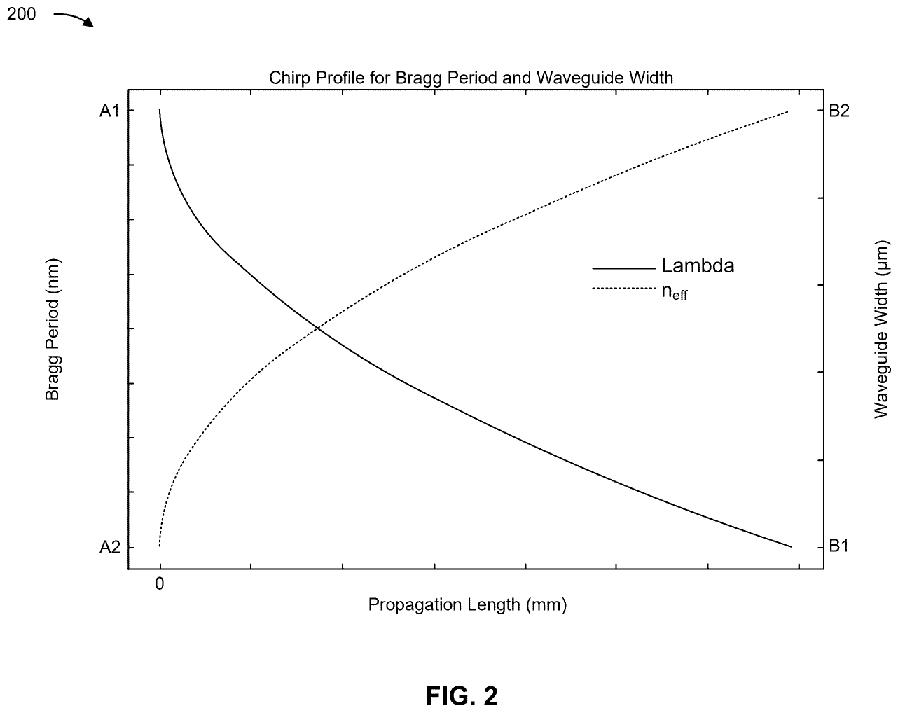

FIG. 2 shows a diagram 200 of two chirp profiles along a WBG propagation length according to one or more implementations. The chirp profiles include a chirp profile for the waveguide effective index n_{eff} and a chirp profile for the Bragg period Λ_{Bragg} (lambda). In this example, the Bragg period Λ_{Bragg} is varied (gradually) between a maximum value Λ1 and a minimum value A2 (e.g., in nanometers nm) with a square-root function along the propagation length of a WBG. At a beginning of the WBG, the Bragg period Λ_{Bragg} has the maximum value A1 and, at an ending of the WBG, the Bragg period A Bragg is the minimum value A2. A width of the WBG (e.g., of the waveguide) is varied (gradually) between a minimum value B1 and a maximum value B2 (e.g., in micrometers μm) with a square-root function along the propagation length of the WBG. At the beginning of the WBG, the width is the minimum value B1 and, at the ending of the WBG, the width is maximum value B2. Thus, the waveguide effective index n_{eff} is increased along the propagation length in one possible propagation direction with a first square root profile, and the Bragg period Λ_{Bragg} is decreased along the propagation length in the propagation direction with a second square root profile. As a result, a double chirp profile is achieved.

For fiber dispersion compensation, the chirp on the Bragg period Λ_{Bragg} is negative and the chirp on the waveguide effective index n_{eff} (or width) is positive. While the square root profile is beneficial for providing non-linear phase and is also feasible in fabrication, other mathematical functions for the chirps may be employed. Thus, the chirps each have a chirping profile with a given mathematical function. Chirping two waveguide parameters, the waveguide effective index n_{eff} (related to waveguide width) and Bragg period (related to periodic perturbations), is provided, in combination, in a single waveguide. Thus, the two chirps are overlapped in a same waveguide structure. Both chirps are combined by designing chirp parameters that sum-up both group delay effects to have a desired dispersion profile that compensates for a range of chromatic dispersion values.

As indicated above, FIG. 2 is provided as an example. Other examples may differ from what is described with regard to FIG. 2.

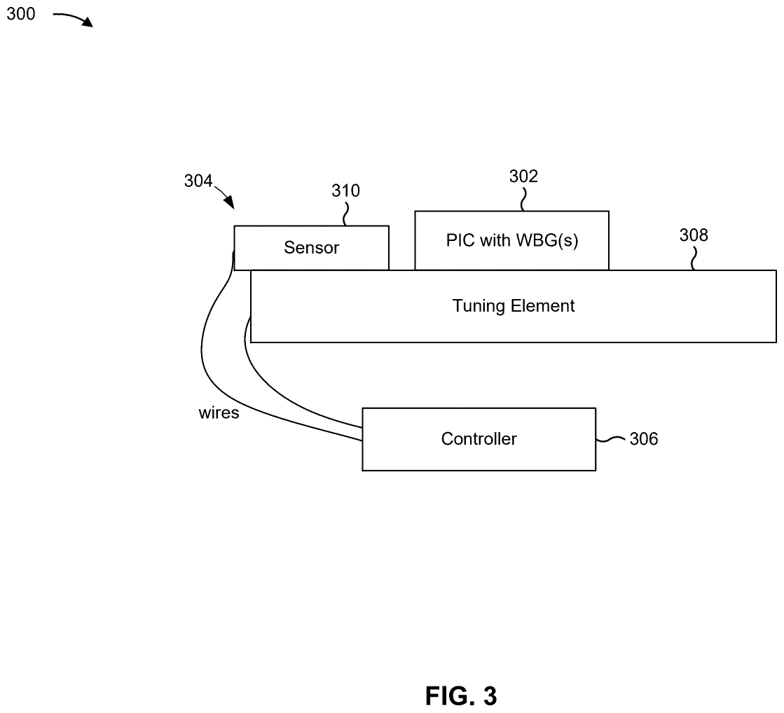

FIG. 3 shows an optical system 300 according to one or more implementations. The optical system 300 may include a photonic integrated circuit 302 and a tuning system 304 that may include a controller 306, a tuning element 308, and a sensor 310. The photonic integrated circuit 302 may be similar to the photonic integrated circuit 100 described on connection with FIGS. 1A and 1B. The photonic integrated circuit 302 may have one or more waveguides, with each waveguide having a WBG with a respective double chirp profile, as described above. For example, the photonic integrated circuit 302 may include waveguide 102 having WBG 108.

Each WBG may be configured to provide a respective non-linear group delay having a tunable level of dispersion. The tuning element 308 may be configured to change a property of each WBG to adjust the tunable levels of dispersion of each WBG. For example, each WBG may have a refractive index that is sensitive to an external influence applied by the tuning element 308. The tuning element may be configured to adjust the external influence in order to adjust the non-linear group delay, and thereby adjust the tunable level of dispersion, of each WBG. The external influence may be a temperature, a strain, or another mechanism designed to adjust the non-linear group delay of a WBG to provide group delay compensation.

In some implementations, each WBG has a respective tunable Bragg reflection wavelength bandwidth having a respective tunable center frequency (e.g., a respective tunable central wavelength). The tuning element 308 may be configured to apply the external influence to change a property of each WBG in order to adjust the respective tunable center frequency of each WBG. Different WBGs may have different center frequencies under a same tuning condition or a same tuning setting. Thus, one of the WBGs may be selected for operation based on a center frequency being tuned to provide a desired level of dispersion (e.g., based on a desired center frequency).

The controller 306 may be configured to regulate a magnitude of the external influence. For example, the tuning element 308 may be a temperature element configured to regulate a temperature of the photonic integrated circuit 302, and the controller 306 may control a temperature of the tuning element 308. For example, the controller 306 may be a thermoelectric controller that controls a current that drives the tuning element 308. The tuning element 308 may be configured to heat and/or cool the photonic integrated circuit 302. Additionally, or alternatively, the tuning element 308 may be a strain element that is coupled to the photonic integrated circuit 302 in such a way as to couple strain into the photonic integrated circuit 302. The controller 306 may control the strain of the tuning element 308.

The sensor 310 may be configured to measure the external influence and provide feedback to the controller 306 such that the controller 306 can regulate the magnitude of the external influence to achieve a target magnitude. For example, the sensor 310 may be temperature sensor or a strain sensor. The center frequency of each WBG may be adjusted to respective target center frequencies based on the target magnitude of the external influence.

In some implementations, the tuning system 304 may be a temperature regulator configured to regulate a temperature of the photonic integrated circuit 302, and thus the temperature of each WBG. The Bragg reflection wavelength bandwidth of each WBG may be dependent on the temperature. Thus, the temperature regulator may to tune the Bragg reflection wavelength bandwidth of the each WBG, by regulating the temperature of each WBG, in order to configure a phase delay response of each WBG.

Thus, dispersion level tuning may be achieved thermically. For example, a Bragg reflection wavelength bandwidth may be shifted in response to a change in a PIC temperature of the photonic integrated circuit 302. For a given optical signal wavelength, the PIC temperature may be set such that a desired chromatic dispersion compensation level matches a signal operating wavelength of the optical signal. A signal frequency of the optical signal should lie within the Bragg reflection wavelength bandwidth. The tuning element 308 may be a thermoelectric cooler (TEC). The sensor 310 may be a thermistor. The controller 306 may implement a control algorithm to control the tuning element 308 based on a measurement obtained by the controller 306 from the sensor 310.

For example, the temperature regulator may tune (e.g., via thermal tuning) the Bragg reflection wavelength bandwidth of the WBG 108 such that an optical signal, having a predefined wavelength, undergoes a desired dispersion and a reflected optical signal has a desired dispersion. In other words, the temperature regulator may tune the Bragg reflection wavelength bandwidth of the WBG 108 such that the phase delay response of the WBG 108 is configured to add dispersion to the optical signal to produce the reflected optical signal with a desired dispersion. Thus, the temperature regulator may tune the Bragg reflection wavelength bandwidth of the WBG 108 such that a chromatic dispersion introduced by the WBG 108 matches a signal operating wavelength of the optical signal. A frequency of the optical signal may be within the Bragg reflection wavelength bandwidth of the WBG 108.

In some implementations, the tuning system 304 may be a strain regulator that operates in a similar manner relative to strain as the temperature regulator operates relative to temperature.

As indicated above, FIG. 3 is provided as an example. Other examples may differ from what is described with regard to FIG. 3.

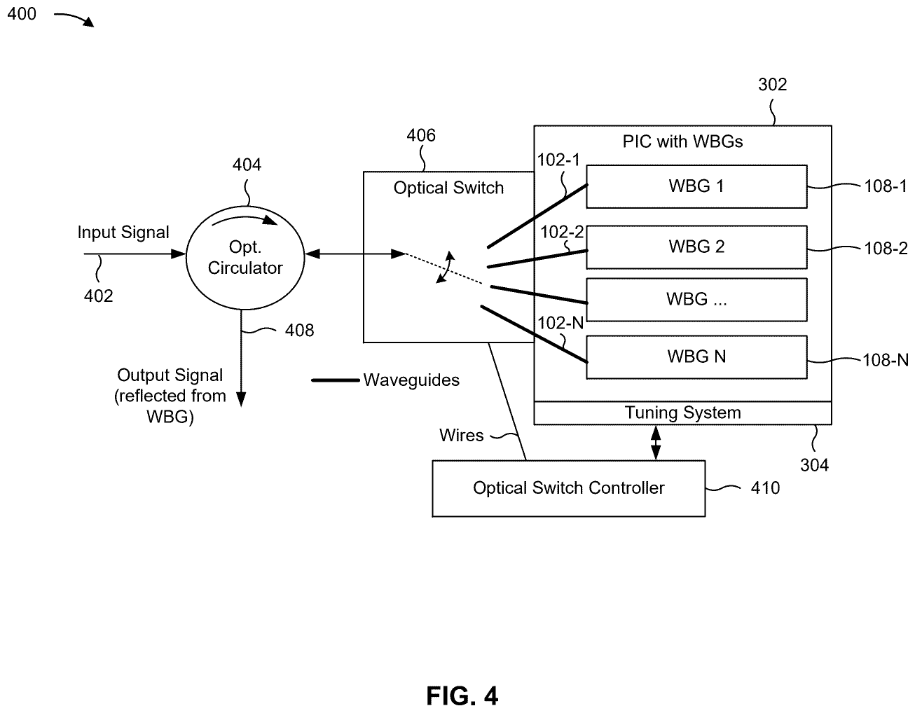

FIG. 4 shows an optical system 400 according to one or more implementations. The optical system 400 may include the photonic integrated circuit 302, the tuning system 304, an input optical fiber 402, an optical circulator 404, an optical switch 406, an output optical fiber 408, and an optical switch controller 410. The photonic integrated circuit 302 may include a plurality of WBGs 108-1, 108-2, . . . , and 108-N, where N in an integer greater than 1. Each WBG may be similar to the WBG 108 described in connection with FIGS. 1A and 1B, except each WBG may have different parameters (e.g., chirps, length, waveguide effective index, pitch), such that each WBG can cover different spectrum regions. Thus, a first WBG 108-1 may have a first double chirp profile, a second WBG 108-2 may have a second double chirp profile, and an N^{th} WBG 108-N may have an N^{th} double chirp profile.

The first WBG 108-1 may provide a first non-linear group delay having a first tunable level of dispersion based on the first double chirp profile. The second WBG 108-2 may provide a second non-linear group delay having a second tunable level of dispersion based on the second double chirp profile. The N^{th} WBG 108-N may provide an N^{th} non-linear group delay having an N^{th} tunable level of dispersion based on the N^{th} double chirp profile. The first non-linear group delay, the second non-linear group delay, and the N^{th} non-linear group delay may be different from each other. The tuning system 304 may be configured to tune the non-linear group delays in other to tune the levels of dispersion provided by each WBG. For example, the first WBG 108-1 may have a first tunable Bragg reflection wavelength bandwidth having a first tunable center frequency, the second WBG 108-2 may have a second tunable Bragg reflection wavelength bandwidth having a second tunable center frequency, and the N^{th} WBG 108-N may have an N^{th} tunable Bragg reflection wavelength bandwidth having an N^{th} tunable center frequency. The first tunable center frequency, the second tunable center frequency, and the N^{th} tunable center frequency may be different under a same tuning condition or a same tuning setting provided by the tuning system 304.

The input optical fiber 402 may provide an input optical signal to the optical circulator 404. The optical circulator 404 may be a three-port circulator that provides the input optical signal to the optical switch 406. The optical switch 406 may be optically coupled to plurality of WBGs 108-1, 108-2, . . . , and 108-N by waveguides 102-1, 102-2, . . . , and 102-N, respectively. The optical switch 406 may be arranged outside of the photonic integrated circuit 302. Alternatively, optical switch 406 may be integrated in the photonic integrated circuit 302.

The optical switch 406 may direct the input optical signal to one of the plurality of WBGs 108-1, 108-2, . . . , and 108-N. For example, the optical switch controller 410 may select one of the plurality of WBGs 108-1, 108-2, . . . , and 108-N to receive the input optical signal based on a desired level of dispersion (e.g., a desired non-linear group delay). In other words, the optical switch 406 may select the WBG from among the plurality of WBGs 108-1, 108-2, . . . , and 108-N that provides the desired level of dispersion. In addition, the levels of dispersion provided by the plurality of WBGs 108-1, 108-2, . . . , and 108-N may be tuned by the tuning system 304. Thus, the tuning system 304 and the optical switch controller 410 may operate in combination to selectively provide the desired level of dispersion. For example, the tuning system 304 may tune the plurality of WBGs 108-1, 108-2, . . . , and 108-N such that one of the tune WBGs provides the desired level of dispersion, and the optical switch controller 410 may control the optical switch 406 to select the tuned WBG that provides the desired level of dispersion. Additionally, the optical switch controller 410 may select one of the plurality of WBGs 108-1, 108-2, . . . , and 108-N based on a wavelength of the input optical signal.

The plurality of WBGs 108-1, 108-2, . . . , and 108-N may have different Bragg reflection wavelength bandwidths with different center frequencies such that the W plurality of WBGs 108-1, 108-2, . . . , and 108-N cover an operating wavelength range. The first WBG 108-1 may provide, in a first Bragg reflection wavelength bandwidth, a first chromatic dispersion corresponding to a first signal operating wavelength of the input optical signal. The second WBG 108-2 may provide, in a second Bragg reflection wavelength bandwidth, a second chromatic dispersion corresponding to a second signal operating wavelength of the input optical signal. The N^{th} WBG 108-N may provide, in an N^{th} Bragg reflection wavelength bandwidth, an N^{th} chromatic dispersion corresponding to an N^{th} signal operating wavelength of the input optical signal. The first Bragg reflection wavelength bandwidth, the second Bragg reflection wavelength bandwidth, and the N^{th} Bragg reflection wavelength bandwidth may have different center frequencies. As a result, first WBG 108-1 may provide a first range of chromatic dispersion over the first Bragg reflection wavelength bandwidth such that the WBG 108-1 is configured to compensate for a first range of light propagation distances in a fiber optic cable, second WBG 108-2 may provide a second range of chromatic dispersion over the second Bragg reflection wavelength bandwidth such that the second WBG 108-2 is configured to compensate for a second range of light propagation distances in a fiber optic cable, and the N^{th} WBG 108-N may provide an N^{th} range of chromatic dispersion over the N^{th} Bragg reflection wavelength bandwidth such that the an N^{th} WBG 108-N is configured to compensate for an N^{th} range of light propagation distances in a fiber optic cable. The fiber optic cable may correspond to the input optical fiber 402, the output optical fiber 408, or a combination of the input optical fiber 40 and the output optical fiber 408. For example, the phase delay response of the selected WBG may be configured to compensate for chromatic dispensation corresponding to a propagation distance of the reflected optical signal through the output optical fiber 408. A group delay profile of the selected WBG may an inverse of a group delay accumulated in the output optical fiber 408 over the propagation distance. The reflected optical signal from the selected WBG may cancel out a phase distortion from the fiber optic cable, since a reflection phase from the selective WBG is configured to match an inverse of a phase distortion introduced by the fiber optic cable. Different WBGs may be configured to compensate for different propagation distances (e.g., different group delay accumulations), and the selected WBG may be selected according to an expected propagation distance.

The selected WBG may receive the input optical signal and reflect the input optical signal as a reflected optical signal (e.g., an output optical signal). The reflected optical signal may be directed, through the optical switch 406, to the optical circulator 404. The optical circulator 404 may provide the reflected optical signal to the output optical fiber 408.

The double chirp design for increased dispersion in a WBG can be used in other applications, such as pulse shaping and ultra-fast lasers.

As indicated above, FIG. 4 is provided as an example. Other examples may differ from what is described with regard to FIG. 4.

The following provides an overview of some Aspects of the present disclosure:

Aspect 1: An optical system, comprising: a photonic integrated circuit comprising: a first waveguide comprising a first end, a second end, and a first waveguide Bragg grating (WBG) arranged between the first end and the second end, wherein the first WBG has a third end, a fourth end, and a first double chirp profile that extends lengthwise, from the third end to the fourth end, along a propagation length of the first WBG, wherein the first WBG includes a first periodic pattern having a first Bragg period that decreases, from the third end to the fourth end, along the propagation length of the first WBG to form a first chirp profile of the first double chirp profile, and wherein the first WBG has a first waveguide effective index that increases, from the third end to the fourth end, along the propagation length of the first WBG to form a second chirp profile of the first double chirp profile.

Aspect 2: The photonic integrated circuit of Aspect 1, wherein the first Bragg period is chirped along the propagation length of the first WBG according to a first non-linear profile, and wherein the first waveguide effective index is chirped along the propagation length of the first WBG according to a second non-linear profile.

Aspect 3: The optical system of Aspect 2, wherein the first non-linear profile and the second non-linear profile change in magnitude in opposite directions along the propagation length of the first WBG.

Aspect 4: The optical system of Aspect 2, wherein the first non-linear profile is a first square-root profile, and wherein the second non-linear profile is a second square-root profile.

Aspect 5: The optical system of any of Aspects 1-4, wherein the first Bragg period decreases incrementally along the propagation length of the first WBG according to a first plurality of non-linear increments, and wherein the first waveguide effective index increases incrementally along the propagation length of the first WBG according to a second plurality of non-linear increments.

Aspect 6: The optical system of any of Aspects 1-5, wherein the first WBG has a variable dimension that increases along the propagation length of the first WBG such that the first waveguide effective index increases along the propagation length of the first WBG.

Aspect 7: The optical system of Aspect 6, wherein the variable dimension is a variable width or a variable height of the first WBG.

Aspect 8: The optical system of any of Aspects 1-7, wherein the first periodic pattern is a perturbation pattern having a plurality of perturbation segments arranged in series along the propagation length of the first WBG, and wherein a pitch between consecutive pairs of perturbations decreases along the propagation length of the first WBG.

Aspect 9: The optical system of Aspect 8, wherein the perturbation pattern is shaped along the propagation length of the first WBG according to an apodization function.

Aspect 10: The optical system of any of Aspects 1-9, wherein the first periodic pattern is a corrugated pattern having a plurality of corrugation segments, and wherein a pitch between consecutive pairs of corrugation segments decreases along the propagation length of the first WBG.

Aspect 11: The optical system of any of Aspects 1-10, wherein the third end is arranged at or proximate to the first end, and wherein the fourth end is arranged at or proximate to the second end.

Aspect 12: The optical system of any of Aspects 1-11, wherein, based on the first double chirp profile, the first WBG has a reflection bandwidth that is characterized by a non-linear wavelength-dependent group-delay profile such that different levels of chromatic dispersion are provided over the reflection bandwidth.

Aspect 13: The optical system of any of Aspects 1-12, wherein the first chirp profile is a WBG perturbation profile, wherein the second chirp profile is a waveguide effective index profile, wherein the first WBG has a Bragg reflection wavelength bandwidth that depends on the first chirp profile along the propagation length of the first WBG and the second chirp profile along the propagation length of the first WBG, and wherein the Bragg reflection wavelength bandwidth changes along the propagation length of the first WBG.

Aspect 14: The optical system of any of Aspects 1-13, wherein the first waveguide is configured to receive an optical signal at the first end such that the first WBG receives the optical signal at the third end, wherein the first WBG is configured to reflect the optical signal by a plurality of local reflections as the optical signal propagates from the third end toward the fourth end resulting in a reflected optical signal that is output from the first end, and wherein the first WBG is configured to provide a phase delay response to the optical signal, for generating the reflected optical signal, based on a Bragg reflection wavelength bandwidth of the first WBG.

Aspect 15: The optical system of Aspect 14, further comprising: a temperature regulator configured to regulate a temperature of the first WBG, wherein the Bragg reflection wavelength bandwidth is dependent on the temperature, and wherein the temperature regulator is configured to tune the Bragg reflection wavelength bandwidth of the first WBG, by regulating the temperature of the first WBG, in order to configure the phase delay response.

Aspect 16: The optical system of Aspect 15, wherein the temperature regulator is configured to tune the Bragg reflection wavelength bandwidth such that the optical signal, having a predefined wavelength, undergoes a desired dispersion and the reflected optical signal has the desired dispersion.

Aspect 17: The optical system of Aspect 15, wherein the temperature regulator is configured to tune the Bragg reflection wavelength bandwidth of the first WBG such that the phase delay response is configured to add dispersion to the optical signal to produce the reflected optical signal with a desired dispersion.

Aspect 18: The optical system of Aspect 15, wherein the temperature regulator is configured to tune the Bragg reflection wavelength bandwidth of the first WBG such that a chromatic dispersion introduced by the first WBG matches a signal operating wavelength of the optical signal, and wherein a frequency of the optical signal is within the Bragg reflection wavelength bandwidth of the first WBG.

Aspect 19: The optical system of Aspect 14, further comprising: a tuning element, wherein the first WBG is configured to provide a non-linear group delay having a tunable level of dispersion, and wherein the tuning element is configured to change a property of the first WBG to adjust the tunable level of dispersion.

Aspect 20: The optical system of Aspect 19, wherein the first WBG has a refractive index that is sensitive to an external influence applied by the tuning element, and wherein the tuning element is configured to adjust the external influence in order to adjust the non-linear group delay and thereby adjust the tunable level of dispersion.

Aspect 21: The optical system of Aspect 14, wherein the first WBG is configured to reflect the optical signal to introduce a phase distortion in the reflected optical signal with a phase delay response from the first WBG, and wherein the phase distortion is an inverse to a transmission phase distortion introduced by a transmission of light through an optical fiber.

Aspect 22: The optical system of Aspect 14, wherein the first WBG is configured to compensate for a range of chromatic dispersion values from an optical fiber, wherein the range of chromatic dispersion values corresponds to a given distance range of propagation through the optical fiber.

Aspect 23: The optical system of Aspect 14, wherein the phase delay response is a non-linear phase delay response that depends on the Bragg reflection wavelength bandwidth of the first WBG.

Aspect 24: The optical system of any of Aspects 1-23, wherein the first waveguide is configured to receive an optical signal at the first end such that the first WBG receives the optical signal at the third end, wherein the first WBG is configured to reflect the optical signal by a plurality of local reflections as the optical signal propagates from the third end toward the fourth end resulting in a reflected optical signal that is output from the first end, and wherein the first double chirp profile provides a phase distortion in the reflected optical signal that is configured to counteract a chromatic dispersion that accumulates in the reflected optical signal as the reflected optical signal propagates in an optical fiber over a predefined distance.

Aspect 25: The optical system of any of Aspects 1-24, wherein the first waveguide is configured to receive an optical signal at the second end such that the first WBG receives the optical signal at the fourth end, wherein the first WBG is configured to reflect the optical signal by a plurality of local reflections as the optical signal propagates toward the third end resulting in a reflected optical signal that is output from the second end, and wherein the first WBG is configured to compress the optical signal to generate the reflected optical signal as a compressed optical signal.

Aspect 26: The optical system of any of Aspects 1-25, further comprising: a second waveguide comprising a fifth end, a sixth end, and a second WBG arranged between the fifth end and the sixth end, wherein the second WBG has a seventh end, an eighth end, and a second double chirp profile that extends lengthwise, from the seventh end to the eighth end, along a propagation length of the second WBG, wherein the second WBG includes a second periodic pattern having a second Bragg period that decreases, from the seventh end to the eighth end, along the propagation length of the second WBG to form a first chirp profile of the second double chirp profile, wherein the second WBG has a second waveguide effective index that increases, from the seventh end to the eighth end, along the propagation length of the second WBG to form a second chirp profile of the second double chirp profile, and wherein the first double chirp profile and the second double chirp profile are different; and an optical switch optically coupled to the first waveguide and the second waveguide, and configured to receive an optical signal and provide the optical signal to the first waveguide or the second waveguide based on a wavelength of the optical signal.

Aspect 27: The optical system of Aspect 26, wherein the first WBG and the second WBG have different Bragg reflection wavelength bandwidths with different center frequencies such that the first WBG and the second WBG cover an operating wavelength range.

Aspect 28: The optical system of Aspect 26, wherein the first WBG is configured to provide, in a first Bragg reflection wavelength bandwidth, a first chromatic dispersion corresponding to a first signal operating wavelength of the optical signal, wherein the second WBG is configured to provide, in a second Bragg reflection wavelength bandwidth, a second chromatic dispersion corresponding to a second signal operating wavelength of the optical signal, wherein the first Bragg reflection wavelength bandwidth and the second Bragg reflection wavelength bandwidth have different center frequencies, wherein the first WBG provides a first range of chromatic dispersion over the first Bragg reflection wavelength bandwidth such that the first WBG is configured to compensate for a first range of light propagation distances in a fiber optic cable, and wherein the second WBGs provides a second range of chromatic dispersion over the second Bragg reflection wavelength bandwidth such that the second WBG is configured to compensate for a second range of light propagation distances in the fiber optic cable.

Aspect 29: The optical system of Aspect 26, the first WBG is configured to provide a first non-linear group delay having a first tunable level of dispersion, the second WBG is configured to provide a second non-linear group delay having a second tunable level of dispersion, and wherein the first non-linear group delay is different from the second non-linear group delay.

Aspect 30: The optical system of Aspect 26, wherein the first WBG has a first tunable Bragg reflection wavelength bandwidth having a first tunable center frequency, wherein the second WBG has a second tunable Bragg reflection wavelength bandwidth having a second tunable center frequency, and wherein the first tunable center frequency and the second tunable center frequency are different under a same tuning condition or a same tuning setting.

Aspect 31: A system configured to perform one or more operations recited in one or more of Aspects 1-30.

Aspect 32: An apparatus comprising means for performing one or more operations recited in one or more of Aspects 1-30.

Aspect 33: A non-transitory computer-readable medium storing a set of instructions, the set of instructions comprising one or more instructions that, when executed by a device, cause the device to perform one or more operations recited in one or more of Aspects 1-30.

Aspect 34: A computer program product comprising instructions or code for executing one or more operations recited in one or more of Aspects 1-30.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical system, comprising:
a photonic integrated circuit comprising:
a first waveguide comprising a first end, a second end, and a first waveguide Bragg grating (WBG) arranged between the first end and the second end,
wherein the first WBG has a third end, a fourth end, and a first double chirp profile that extends lengthwise, from the third end to the fourth end, along a propagation length of the first WBG,
wherein the first WBG includes a first periodic pattern having a first Bragg period that decreases, from the third end to the fourth end, along the propagation length of the first WBG to form a first chirp profile of the first double chirp profile, and
wherein the first WBG has a first waveguide effective index that increases, from the third end to the fourth end, along the propagation length of the first WBG to form a second chirp profile of the first double chirp profile.

2. The photonic integrated circuit of claim 1, wherein the first Bragg period is chirped along the propagation length of the first WBG according to a first non-linear profile, and
wherein the first waveguide effective index is chirped along the propagation length of the first WBG according to a second non-linear profile.

3. The optical system of claim 2, wherein the first non-linear profile and the second non-linear profile change in magnitude in opposite directions along the propagation length of the first WBG.

4. The optical system of claim 2, wherein the first non-linear profile is a first square-root profile, and
wherein the second non-linear profile is a second square-root profile.

5. The optical system of claim 1, wherein the first Bragg period decreases incrementally along the propagation length of the first WBG according to a first plurality of non-linear increments, and
wherein the first waveguide effective index increases incrementally along the propagation length of the first WBG according to a second plurality of non-linear increments.

6. The optical system of claim 1, wherein the first WBG has a variable dimension that increases along the propagation length of the first WBG such that the first waveguide effective index increases along the propagation length of the first WBG.

7. The optical system of claim 6, wherein the variable dimension is a variable width or a variable height of the first WBG.

8. The optical system of claim 1, wherein the first periodic pattern is a perturbation pattern having a plurality of perturbation segments arranged in series along the propagation length of the first WBG, and
wherein a pitch between consecutive pairs of perturbations decreases along the propagation length of the first WBG.

9. The optical system of claim 8, wherein the perturbation pattern is shaped along the propagation length of the first WBG according to an apodization function.

10. The optical system of claim 1, wherein the first periodic pattern is a corrugated pattern having a plurality of corrugation segments, and
wherein a pitch between consecutive pairs of corrugation segments decreases along the propagation length of the first WBG.

11. The optical system of claim 1, wherein the third end is arranged at or proximate to the first end, and
wherein the fourth end is arranged at or proximate to the second end.

12. The optical system of claim 1, wherein, based on the first double chirp profile, the first WBG has a reflection bandwidth that is characterized by a non-linear wavelength-dependent group-delay profile such that different levels of chromatic dispersion are provided over the reflection bandwidth.

13. The optical system of claim 1, wherein the first chirp profile is a WBG perturbation profile,
wherein the second chirp profile is a waveguide effective index profile,
wherein the first WBG has a Bragg reflection wavelength bandwidth that depends on the first chirp profile along the propagation length of the first WBG and the second chirp profile along the propagation length of the first WBG, and
wherein the Bragg reflection wavelength bandwidth changes along the propagation length of the first WBG.

14. The optical system of claim 1, wherein the first waveguide is configured to receive an optical signal at the first end such that the first WBG receives the optical signal at the third end,
wherein the first WBG is configured to reflect the optical signal by a plurality of local reflections as the optical signal propagates from the third end toward the fourth end resulting in a reflected optical signal that is output from the first end, and
wherein the first WBG is configured to provide a phase delay response to the optical signal, for generating the reflected optical signal, based on a Bragg reflection wavelength bandwidth of the first WBG.

15. The optical system of claim 14, further comprising:
a temperature regulator configured to regulate a temperature of the first WBG,
wherein the Bragg reflection wavelength bandwidth is dependent on the temperature, and
wherein the temperature regulator is configured to tune the Bragg reflection wavelength bandwidth of the first WBG, by regulating the temperature of the first WBG, in order to configure the phase delay response.

16. The optical system of claim 15, wherein the temperature regulator is configured to tune the Bragg reflection wavelength bandwidth such that the optical signal, having a predefined wavelength, undergoes a desired dispersion and the reflected optical signal has the desired dispersion.

17. The optical system of claim 15, wherein the temperature regulator is configured to tune the Bragg reflection wavelength bandwidth of the first WBG such that the phase delay response is configured to add dispersion to the optical signal to produce the reflected optical signal with a desired dispersion.

18. The optical system of claim 15, wherein the temperature regulator is configured to tune the Bragg reflection wavelength bandwidth of the first WBG such that a chromatic dispersion introduced by the first WBG matches a signal operating wavelength of the optical signal, and wherein a frequency of the optical signal is within the Bragg reflection wavelength bandwidth of the first WBG.

19. The optical system of claim 14, further comprising:
a tuning element,
wherein the first WBG is configured to provide a non-linear group delay having a tunable level of dispersion, and
wherein the tuning element is configured to change a property of the first WBG to adjust the tunable level of dispersion.

20. The optical system of claim 19, wherein the first WBG has a refractive index that is sensitive to an external influence applied by the tuning element, and
wherein the tuning element is configured to adjust the external influence in order to adjust the non-linear group delay and thereby adjust the tunable level of dispersion.

21. The optical system of claim 14, wherein the first WBG is configured to reflect the optical signal to introduce a phase distortion in the reflected optical signal with a phase delay response from the first WBG, and
wherein the phase distortion is an inverse to a transmission phase distortion introduced by a transmission of light through an optical fiber.

22. The optical system of claim 14, wherein the first WBG is configured to compensate for a range of chromatic dispersion values from an optical fiber, wherein the range of chromatic dispersion values corresponds to a given distance range of propagation through the optical fiber.

23. The optical system of claim 14, wherein the phase delay response is a non-linear phase delay response that depends on the Bragg reflection wavelength bandwidth of the first WBG.

24. The optical system of claim 1, wherein the first waveguide is configured to receive an optical signal at the first end such that the first WBG receives the optical signal at the third end,
wherein the first WBG is configured to reflect the optical signal by a plurality of local reflections as the optical signal propagates from the third end toward the fourth end resulting in a reflected optical signal that is output from the first end, and
wherein the first double chirp profile provides a phase distortion in the reflected optical signal that is configured to counteract a chromatic dispersion that accumulates in the reflected optical signal as the reflected optical signal propagates in an optical fiber over a predefined distance.

25. The optical system of claim 1, wherein the first waveguide is configured to receive an optical signal at the second end such that the first WBG receives the optical signal at the fourth end,
wherein the first WBG is configured to reflect the optical signal by a plurality of local reflections as the optical signal propagates toward the third end resulting in a reflected optical signal that is output from the second end, and
wherein the first WBG is configured to compress the optical signal to generate the reflected optical signal as a compressed optical signal.

26. The optical system of claim 1, further comprising:
a second waveguide comprising a fifth end, a sixth end, and a second WBG arranged between the fifth end and the sixth end,
wherein the second WBG has a seventh end, an eighth end, and a second double chirp profile that extends lengthwise, from the seventh end to the eighth end, along a propagation length of the second WBG,
wherein the second WBG includes a second periodic pattern having a second Bragg period that decreases, from the seventh end to the eighth end, along the propagation length of the second WBG to form a first chirp profile of the second double chirp profile,
wherein the second WBG has a second waveguide effective index that increases, from the seventh end to the eighth end, along the propagation length of the second WBG to form a second chirp profile of the second double chirp profile, and
wherein the first double chirp profile and the second double chirp profile are different; and
an optical switch optically coupled to the first waveguide and the second waveguide, and configured to receive an optical signal and provide the optical signal to the first waveguide or the second waveguide based on a wavelength of the optical signal.

27. The optical system of claim 26, wherein the first WBG and the second WBG have different Bragg reflection wavelength bandwidths with different center frequencies such that the first WBG and the second WBG cover an operating wavelength range.

28. The optical system of claim 26, wherein the first WBG is configured to provide, in a first Bragg reflection wavelength bandwidth, a first chromatic dispersion corresponding to a first signal operating wavelength of the optical signal,
wherein the second WBG is configured to provide, in a second Bragg reflection wavelength bandwidth, a second chromatic dispersion corresponding to a second signal operating wavelength of the optical signal,
wherein the first Bragg reflection wavelength bandwidth and the second Bragg reflection wavelength bandwidth have different center frequencies,
wherein the first WBG provides a first range of chromatic dispersion over the first Bragg reflection wavelength bandwidth such that the first WBG is configured to compensate for a first range of light propagation distances in a fiber optic cable, and
wherein the second WBGs provides a second range of chromatic dispersion over the second Bragg reflection wavelength bandwidth such that the second WBG is configured to compensate for a second range of light propagation distances in the fiber optic cable.

29. The optical system of claim 26, the first WBG is configured to provide a first non-linear group delay having a first tunable level of dispersion,
the second WBG is configured to provide a second non-linear group delay having a second tunable level of dispersion, and
wherein the first non-linear group delay is different from the second non-linear group delay.

30. The optical system of claim 26, wherein the first WBG has a first tunable Bragg reflection wavelength bandwidth having a first tunable center frequency,
wherein the second WBG has a second tunable Bragg reflection wavelength bandwidth having a second tunable center frequency, and
wherein the first tunable center frequency and the second tunable center frequency are different under a same tuning condition or a same tuning setting.
